(19) United States
(12) Patent Application Publication
(10) Pub. No.: US 2010/0161716 A1
(43) Pub. Date: Jun. 24, 2010

(54) METHOD AND APPARATUS FOR STREAMING MULTIPLE SCALABLE CODED VIDEO CONTENT TO CLIENT DEVICES AT DIFFERENT ENCODING RATES

(75) Inventors: George W. Kajos, Westborough, MA (US); Gary Hughes, Chelmsford, MA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 12/341,222

(22) Filed: Dec. 22, 2008

(51) Int. Cl. G06F 15/16

(52) U.S. Cl. 709/203

(57) ABSTRACT

A method of delivering content to a client device over a network includes establishing communication with a first client device over a network. A first message is received over the network that indicates the content rendering capabilities of the first client device. Based on the first message, content is transmitted to the first client device over the network in a format that is fully decodable by the first client device in accordance with its content rendering capabilities.

### FIELD OF THE INVENTION

The present invention relates generally to a method and apparatus for streaming media content to clients, and more particularly to a method and apparatus for streaming media content to a client in a scalable coded format.

### BACKGROUND

The use of streaming media servers to support cable television, IPTV, and wireless video transmission present many challenges. For instance, different clients such as standard definition (SD) and high definition (HD) set top terminals, personal computers and PDAs and mobile phones can have different display, power, communication, and computational capabilities. A successful video streaming system needs to be able to stream video to these heterogeneous clients. By way of example, in the context of cable television and IPTV, industry standard transmission rates support both standard definition and high definition. Because of the difference in encoding between an SD and an HD version of the same program, the HD version typically requires a 4-5 times higher transmission rate and 4-5 times more storage space on the server. Depending on the encoding technique and the length of program, typical transmission rates range from between 2-4 Mbps for SD programming and 8-15 Mbps for HD programming transmission rates and typical file storage requirements range from around 0.75-1.66 GBytes/hour for SD and 3-7 GBytes/hour for HD. In contrast, wireless devices, which typically support much lower network interface transmission rates and much lower display resolutions, have transmission rates of about 0.256-1 Mbps and file storage requirements of 100-400 Mbytes/hour.

One way to support a wide variety of different client devices without maintaining multiple files of the same program in different formats is to employ scalable coding techniques. Scalable coding generates multiple layers, for example a base layer and an enhancement layer, for the encoding of video data. The base layer typically has a lower bit rate and lower spatial resolution and quality, while the enhancement layer increases the spatial resolution and quality of the base layer, thus requiring a higher bit rate. The enhancement layer bitstream is only decodable in conjunction with the base layer, i.e. it contains references to the decoded base layer video data which are used to generate the final decoded video data.

Scalable encoding has been accepted for incorporation into established standards, including the ITU-T.H.264 (hereinafter “H.264”) standard and its counterpart, ISO/IEC MPEG-4, Part 10, i.e., Advanced Video Coding (AVC). More specifically, the scalable encoding recommendations that are to be incorporated into the standards may be found in ITU-T Rec. H.264|ISO/IEC 14496-10/Amd.3 Scalable video coding 2007/11, currently published as document JVT-X201 of the Joint Video Team (JVT) of ISO/IEC MPEG & ITU-T VCEG (ISO/IEC JTC1/SC29/WG11 and ITU-T SG16 Q.6).

By using scalable coding, a single file can be streamed to client devices with different capabilities. Each client device can then decode only those layers it needs and is capable of supporting. One problem with this technique, however, is that it unnecessarily consumes substantial amounts of bandwidth when the file is streamed with more bits of data than a client device can accept. In other words, bandwidth is wasted when a less capable client device throws away bits that it cannot use. Additionally, conventional scalable coding techniques place a significant computational burden on the client device to decode and display only those components of a program that it is capable of displaying.

### SUMMARY OF THE INVENTION

In accordance with the present invention, a method of delivering content to a client device over a network includes establishing communication with a first client device over a network. A first message is received over the network that indicates the content rendering capabilities of the first client device. Based on the first message, content is transmitted to the first client device over the network in a format that is fully decodable by the first client device in accordance with its content rendering capabilities.

In accordance another aspect of the invention, a headend is provided for delivering content over one or more networks. The headend includes a scalable transcoder for receiving programming content and generating a scalably encoded programming stream therefrom. The scalably encoded programming stream includes a plurality of layers. The headend also includes a streaming server for receiving the scalably encoded programming stream. The streaming server, responsive to a user request for the programming content, is configured to output for transmission over a network a transport stream in which the content is encoded at a bit rate corresponding to a resolution capability of a client device from which the user request is received.

### BRIEF DESCRIPTION OF THE DRAWINGS

FIG. 1 shows one example of an architecture that can be used to deliver video and other content and services to client devices.

FIG. 2 shows another example of an architecture that can be used to deliver video and other content and services to client devices.

FIG. 3 shows one example of an RTP gateway that may be employed in the architectures of FIGS. 1 and 2.

FIG. 4 shows one example of an on-demand streaming server.

FIG. 5 is a block diagram of one illustrative implementation of the streaming server modules shown in FIG. 4.

FIG. 6 is a flowchart illustrating one example of a method for delivering content to a client device over a network.

### DETAILED DESCRIPTION

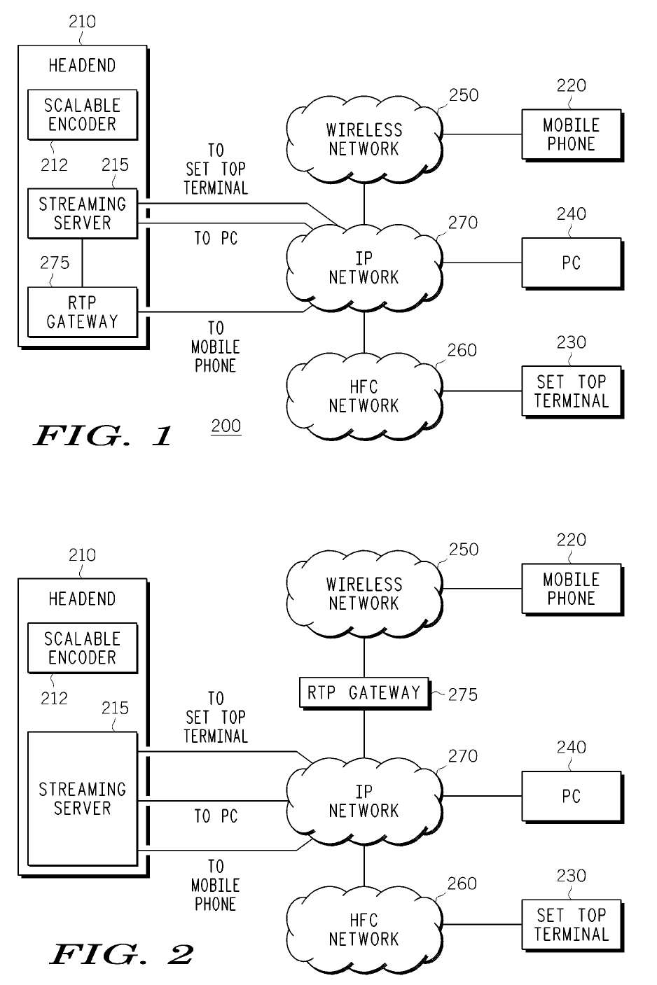

FIG. 1 shows one example of an architecture 200 that can be used to deliver video and other content and services to users associated with a variety of different client devices, which may include, without limitation, PCs, PDAs, portable computers, media centers, portable media players, mobile telephones and set-top boxes. In this illustrative example, three client devices are shown, a mobile phone 220, a set top terminal 230 and a personal computer (PC) 240. A headend 210 is in communication with each of the client devices 220, 230 and 240 via IP network 270. Mobile phone 220 communicates with headend 210 over the IP network 270 and a wireless network such as a GSM or a UMTS network, for example. Set top terminal 230 communicates with headend 210 over the IP network 270 and a hybrid fiber/coax (HFC) network 260 and PC 240 communicates with the headend 210 over the IP network 270, typically via an Internet service provider (not shown). Of course, the architecture depicted in FIG. 1 is presented for illustrative purposes only. More generally, a wide variety of different client devices may communicate with the headend over other types of networks including, for instance, all-coaxial, xDSL (e.g., ADSL, ADSL2, ADSL2+, VDSL, and VDSL2) and satellite systems.

The headend 210 is the facility from which a network operator delivers programming content and provides other services to the client devices. As detailed below, the headend 210 may include a streaming server 215 for streaming the programming content that is encoded by a scalable encoder 212. The term “streaming” is used to indicate that the data representing the media content is provided over a network to a client device and that playback of the content can begin prior to the content being delivered in its entirety (e.g., providing the data on an as-needed basis rather than pre-delivering the data in its entirety before playback).

In a conventional arrangement, the headend maintains and manages multiple copies of each program. Each copy contains a different rendition of the program that is tailored to the display characteristics of the different client devices. When scalable coding is employed, each client device receives the same scalable coded transport stream that is delivered by the headend 210. The client devices decode the transport stream in accordance with their own capabilities. Thus, for example, the mobile phone 220 may only decode the base layer, whereas the set top terminal 230 may decode the base layer and, say, a single enhancement layer if it only supports standard definition programming and all the available enhancement layers if it supports high definition programming. However, as previously mentioned, one problem with scalable coding is that it consumes excessive amounts of bandwidth that is wasted when delivering scalable coded transport streams to less capable devices. It also places a significant computational burden on the client device to decode and display only those components of a program that it is capable of displaying.

To overcome the aforementioned problem, in accordance with the methods and techniques described herein, instead of delivering the same scalable coded transport stream to the client devices, the streaming server 215 delivers to each client device only those layers in the scalable coded stream that it can decode. That is, the streaming server 215 acts as a scalable transcoder that forms a transport stream appropriate to each of the client devices. For instance, the streaming server may only deliver the base layer to the mobile phone 220. On the other hand, the streaming server 215 may deliver the base layer as well as one or more enhancement layers to the set top terminal 230. In this way, instead of placing the computational burden on the client devices to decode and display only those layers it needs, the computational burden is placed on the streaming server 215, which generally will have far more processing capabilities and other resources than the client devices. Moreover, network bandwidth is conserved because the bit rate of the transport streams delivered to less capable client devices is reduced since not all the layers are being transmitted.

In order to employ the streaming server 215 as a scalable transcoder in the manner described above, the streaming server 215 needs to be able to extract the base layer and selected enhancement layers from the scalable coded transport stream it receives from the scalable encoder 212. In addition, the media streams generated by the streaming server 215 need to be encapsulated in a format appropriate for the individual client devices. For instance, higher end client devices such as set top terminals typically receive content encapsulated in an MPEG-2 Transport Stream whereas lower end client devices such as a PDA receive content encapsulated using a transport protocol such as the real-time protocol (RTP). Finally, the streaming server 215 needs to be able to determine the capabilities of the client devices when a communication session is established so that it can deliver the proper number of encoding layers to the client devices. Each of these issues will be addressed in turn below.

The streaming server 215 can extract the appropriate layers from the scalable coded video stream in a variety of different ways. For example, the streaming server 215 can examine the incoming stream received from the scalable encoder 212 to determine the packet ID (PID) types, the location of key frames, bit rate and other pertinent information. In particular, the streaming server 215 can distinguish between the PIDs assigned to packets that carry the base layer and the PIDs assigned to packets that contain each enhancement layer. In this way when the streaming server 215 is delivering content to a particular client device, it can drop any packets having a PID assigned to an enhancement layer that is not needed by that client device.

As is well known to those of ordinary skill in the art, transport of media streams requires a video encoding standard, such as MPEG-2 or H.264, and a transport standard such as MPEG-2 Transport Stream or Real-Time Protocol (RTP), as well as coding standards for audio and ancillary data. One benefit that arises from the use of the MPEG-2 Transport Stream is that all the components (e.g., video, audio, closed caption or subtitles) in the stream are time synchronized so that they can be displayed in an appropriate manner. Since many higher end devices such as set top terminals are capable of receiving and decoding MPEG-2 Transport Streams, streaming server 215 will typically deliver the encoded content in this format. On the other hand, if, for instance, RTP is used as the delivery mechanism, the different components of the content such as video, audio, closed caption or subtitles are delivered in separate transport streams with their own time references that need to be synchronized with one another by way of timing messages delivered by RTCP. Accordingly, if streaming server 215 generates a scalable coded video stream in a format such as H.264, which is then encapsulated in an MPEG-2 Transport Stream, the MPEG-2 Transport Stream will need to be torn apart into its individual components and reconstructed to encapsulate them into separate RTP transport streams. In the example shown in FIG. 1 mobile phone 220 receives the content in accordance with RTP. Accordingly, an RTP gateway 275 is employed between the output of the streaming server 215 and the wireless network 250. The RTP gateway 275 transforms the MPEG-2 transport packet provided by the streaming server 215 into the appropriate RTP transport packets. Since the PC 240 and the set top terminal 230 can receive MPEG-2 Transport Streams, no such gateway is necessary between the streaming server 215 and these devices. In this example the RTP gateway 275 may be included in the headend 210.

FIG. 2 shows an architecture similar to that depicted in FIG. 1, except that in FIG. 2 the RTP gateway 275 is located between the IP network 270 and the wireless network 250. In FIGS. 1 and 2 like elements are denoted by like reference numerals.

As noted above, one issue the RTP gateway 275 needs to address is the different ways in which timing information is handled in an MPEG-2 Transport Stream and an RTP transport stream. In MPEG-2, reference packets in each component of the transport stream contain a timestamp. Other packets that do not include a timestamp derive timing information based on their position with respect to a reference packet that does have a timestamp. Because of this, filler packets such as null packets may be transmitted in the transport stream. The filler packets maintain timing information by acting as placeholders. When the MPEG-2 Transport Stream is converted into an RTP transport stream, multiple MPEG-2 packets may be combined into a single RTP packet. Unlike MPEG-2 packets, each RTP packet contains a timestamp. In order to minimize packet overhead and packet processing, when multiple MPEG-2 packets are combined into a single RTP packet, the reference timing information is extracted and the filler packets removed. Relative timing information of the elementary streams is maintained by calculating offset information for the MPEG-2 packets relative to the reference timestamps in the original MPEG-2 Transport Stream. The offset information is then used to schedule the transmission of the RTP packets, thus maintaining the original timing. One example of an RTP gateway that functions in this manner is shown in U.S. Pat. No. 7,248,590.

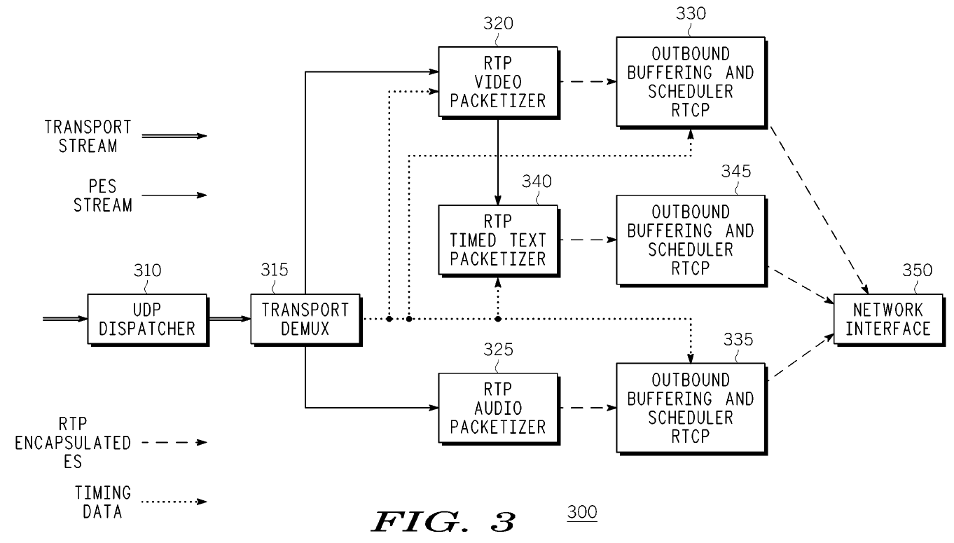

FIG. 3 shows another example of an RTP gateway 300 that may be employed in the architectures of FIGS. 1 and 2. The RTP gateway 300 includes UDP input dispatcher 310, transport demultiplexer 315, RTP packetizers 320, 325 and 340, outbound schedulers 330, 335 and 345 and network interface 350. The UDP input dispatcher 310 receives the transport streams as incoming UDP datagrams from the streaming server 215 on a designated port and passes the transport packets to the transport demultiplexer 315. The dispatcher is responsible for monitoring continuity counters to detect packet loss and for detecting loss of stream by monitoring stream activity. When it detects loss of stream it is responsible for destroying the session and releasing its resources. The transport demultiplexer 315 receives the UDP datagram payload from the UDP input dispatcher 310. If the session between the streaming server 215 and the client device is configured to deliver RTP elementary streams, the transport demultiplexer 315 breaks down the payload by PID type into elementary stream access units (AUs) and inspects the transport PSI data to determine the PIDs and types of the various streams, assuming this information is not provided externally. Since the incoming transport streams contain their own timing references, the transport demultiplexer 315 extracts this information, converts it to RTP and RTCP timing messages and feeds it to the downstream components of the gateway 300. As a result, the timing of the RTP transport streams will be effectively under the control of the streaming server so that the RTP gateway 300 does not require an internal time reference. It also ensures that the RTP stream timestamps maintain audio/video synchronization (“lipsynch”). The transport demultiplexer 315 also discards any packets not intended for RTP transmission, including PSI, null (filling) packets, and extra audio or data streams. For instance, if the original transport stream contains multiple audio or subtitle components, only one audio and one subtitle stream will be propagated; the others will be discarded. Audio and subtitle components may be explicitly selected by specifying a PID in the gateway setup commands. If a PID is not provided it will select the first audio or subtitle component it finds when parsing the PMT in the MPEG-2 Transport Stream.

If the session is configured for the RTP packetization scheme described in RFC 2250, the transport demultiplexer 315 can operate in either a passthrough mode or a selective mode. In the passthrough mode, all packets are passed through and there is a one-to-one correspondence between the received UDP datagrams and the transmitted RTP datagrams, each of which may contain, for example, 7 transport packets. In the selective mode, all the filler transport packets (identified by the null PID) are removed from the stream, resulting in a VBR stream.

The RTP video, audio and text packetizers 320, 325 and 340 accept from the transport demultiplexer 315 the video, audio and text elementary stream access units, respectively, along with their associated timing information extracted from the MPEG Transport Stream. RTP video, audio and text packetizers 320, 325 and 340 then create the RTP packets so that they are ready for transmission. The time stamps contained in the RTP and RTP payload headers are derived from the timing information. In addition to the generic RTP header, RTP defines a payload format, with its associated headers, for each supported data type. Consequently, there will generally be a different packetizer for each stream type that is supported.

Once the RTP video, audio and text packets have been prepared they are respectively passed to outbound schedulers 330, 335 and 345, which buffer the packets until the scheduled transmission time. Transmission scheduling is based on timing information extracted from the transport stream. The default behavior is to pace out the RTP packets at approximately the rate at which the data arrives and to maintain the relative timing of audio and video streams. This avoids buffer overflow conditions at the decoder and helps smooth network traffic.

The outbound schedulers 330, 335 and 345 may provide a mechanism to vary the overall delay as well as the relative delay between the audio, video and text streams. Note that this does not alter the values of the timestamps carried in the RTP packets, only their transmission times. The outbound scheduler 330, 335 and 345 can also be configured to transmit RTP packets as soon as they are available in a so-called unpaced mode.

Each RTP stream has an associated bidirectional UDP connection to handle RTCP traffic. This RTCP connection may use a port number one greater than the port of the associated RTP connection. In the RTP gateway 300, this is primarily used to send periodic sender reports to synchronize RTP timestamps to a reference clock. By default these sender reports will be sent on some regular basis (e.g., once per second) by the RTP outbound schedulers. The RTP Outbound schedulers will have the ability to optionally record RTCP messages received from clients for later analysis.

As previously mentioned, the streaming server 215 needs to be able to determine the capabilities of the client devices when a communication session is established so that it can deliver the proper number of encoding layers. This can be accomplished using various signalling protocols, including, for example, an application-level signalling protocol such as RTSP or a session-level signalling protocol such as SIP The SIP signalling protocol is typically used to initiate and establish a communication session in lower end client devices that employ RTP transport streams. RTSP, on the other hand, is often employed when MPEG-2 Transport Streams are delivered to higher end client devices. Among other things, RTSP allows client devices to remotely control the streaming media using commands such as play, pause, fast-forward and rewind. SDP, which can be carried in both RTSP and SIP signalling messages, can be used to convey client device capabilities such as rendering capabilities and the like, as well as other session characteristics.

In addition to adapting the stream to client device capabilities, the RTP gateway 300 can monitor performance information returned in the client RTCP messages and can add or remove layers of the scaleable video coding to adapt to changing network conditions. For example, if the RTCP messages indicate that video packets are being dropped in the network, indicating possible network congestion, the RTP gateway 300 could remove one or more enhancement layers to reduce bandwidth requirements.

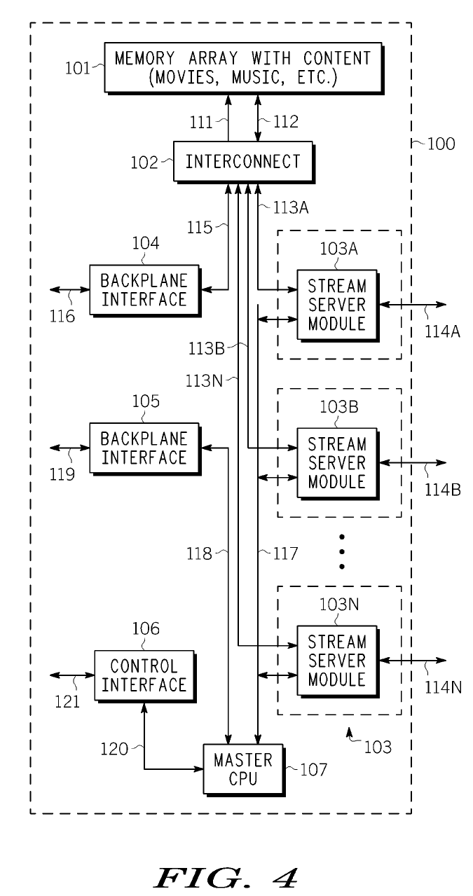

One example of an on-demand streaming server 100 that may employ the methods, techniques and systems described herein is shown in FIG. 4. While the server 100 will be used for purposes of illustration, those of ordinary skill in the art will recognize that the methods, techniques and systems described herein are also applicable to wide variety of the other on-demand streaming servers employing different architectures.

The on-demand streaming server 100 includes a memory array 101, an interconnect device 102, and stream server modules 103a through 103n (103). Memory array 101 is used to store the on-demand content and could be many Gigabytes or Terabytes in size. Such memory arrays may be built from conventional memory solid state memory including, but not limited to, dynamic random access memory (DRAM) and synchronous DRAM (SDRAM). The stream server modules 103 retrieve the content from the memory array 101 and generate multiple asynchronous streams of data that can be transmitted to the client devices. The interconnect 102 controls the transfer of data between the memory array 101 and the stream server modules 103. The interconnect 102 also establishes priority among the stream server modules 103, determining the order in which the stream server modules receive data from the memory array 101.

The communication process starts with a stream request being sent from a client device (e.g., client devices 220, 230 and 240 in FIG. 1) over an associated transport network (e.g., networks 250, 260 and 270). The command for the request arrives over a signal line 114a-114n (114) to a stream server module 103, where the protocol information is decoded. If the request comes in from stream server module 103a, for example, it travels over a bus 117 to a master CPU 107. For local configuration and status updates, the CPU 107 is also connected to a local control interface 106 over signal line 120, which communicates with the system operator over a line 121. Typically this could be a terminal or local computer using a serial connection or network connection.

Control functions, or non-streaming payloads, are handled by the master CPU 107. For instance, stream control in accordance with the RTSP protocol is performed by CPU 107. Program instructions in the master CPU 107 determine the location of the desired content or program material in memory array 101. The memory array 101 is a large scale memory buffer that can store video, audio and other information. In this manner, the server system 100 can provide a variety of content to multiple customer devices simultaneously. Each client device can receive the same content or different content. The content provided to each client device is transmitted as a unique asynchronous media stream of data that may or may not coincide in time with the unique asynchronous media streams sent to other customer devices.

If the requested content is not already resident in the memory array 101, a request to load the program is issued over signal line 118, through a backplane interface 105 and over a signal line 119. An external processor or CPU (not shown) responds to the request by loading the requested program content over a backplane line 116, under the control of backplane interface 104. Backplane interface 104 is connected to the memory array 101 through the interconnect 102. This allows the memory array 101 to be shared by the stream server modules 103, as well as the backplane interface 104. The program content is written from the backplane interface 104, sent over signal line 115, through interconnect 102, over signal line 112, and finally to the memory array 101.

When the first block of program material has been loaded into memory array 101, the streaming output can begin. Streaming output can also be delayed until the entire program has been loaded into memory array 101, or at any point in between. Data playback is controlled by a selected one or more stream server modules 103. If the stream server module 103a is selected, for example, the stream server module 103a sends read requests over signal line 113a, through the interconnect 102, over a signal line 111 to the memory array 101. A block of data is read from the memory array 101, sent over signal line 112, through the interconnect 102, and over signal line 113a to the stream server module 103a. Once the block of data has arrived at the stream server module 103a, the transport protocol stack is generated for this block and the resulting primary media stream is sent to the transport network over signal line 114a. The transport network then carries the primary media stream to the client device. This process is repeated for each data block contained in the program source material.

If the requested program content already resides in the memory array 101, the CPU 107 informs the stream server module 103a of the actual location in the memory array. With this information, the stream server module can begin requesting the program stream from memory array 101 immediately.

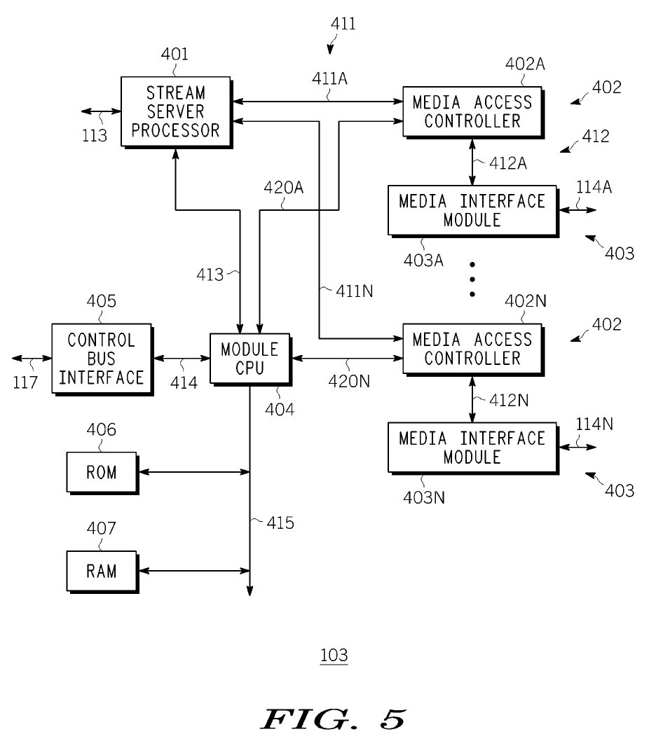

FIG. 5 is a block diagram of one illustrative implementation of the stream server modules 103 shown in FIG. 4. A stream server processor (SSP) 401 serves as the automatic payload requester, as well as the protocol encoder and decoder. The SSP 401 requests and receives data payload over signal line 113. It then encodes and forms network level packets, such as TCP/IP or UDP/IP or the like. The encoded packets are sent out over signal lines 411a-411n (411) to one or more media access controllers (MAC) 402a-402n (402). The media access controllers 402 generate the primary media stream by encapsulating the encoded packets in data link level frames or datagrams as required by the specific physical network used. In the case of Ethernet, for example, the Media Access Controllers 402 also handle the detection of collisions and the auto-recovery of link-level network errors.

The media access controllers 402 are connected utilizing signal lines 412a-412n (412), to media interface modules 403a-403n (403), which are responsible for the physical media of the network connection. This could be a twisted-pair transceiver for Ethernet, Fiber-Optic interface for Ethernet, SONET or many other suitable physical interfaces, which exist now or will be created in the future, such interfaces being appropriate for the physical low-level interface of the desired network. The media interface modules 403 then send the primary media streams over the signal lines 114a-114n (114) to the appropriate client device or devices.

In practice, the stream server processor 401 divides the input and output packets depending on their function. If the packet is an outgoing payload packet, it can be generated directly in the stream server processor (SSP) 401. The SSP 401 then sends the packet to MAC 402a, for example, over signal line 411a. The MAC 402a then uses the media interface module 403a and signal line 412a to send the packet as part of the primary stream to the network over signal line 114a.

Client control requests are received over network line 114a by the media interface module 403a, signal line 412a and MAC 402a. The MAC 402a then sends the request to the SSP 401. The SSP 401 then separates the control packets and forwards them to the module CPU 404 over the signal line 413. The module CPU 404 then utilizes a stored program in ROM/Flash ROM 406, or the like, to process the control packet. For program execution and storing local variables, it is typical to include some working RAM 407. The ROM 406 and RAM 407 are connected to the CPU over local bus 415, which is usually directly connected to the CPU 404.

The module CPU 404 from each stream server module uses signal line 414, control bus interface 405, and bus signal line 117 to forward requests for program content and related system control functions to the master CPU 107 in FIG. 4. By placing a module CPU 404 in each stream server module, the task of session management and session control can be handled close to the network lines 114a-114n. This distributes the CPU load and allows a much greater number of simultaneous stream connections per network interface.

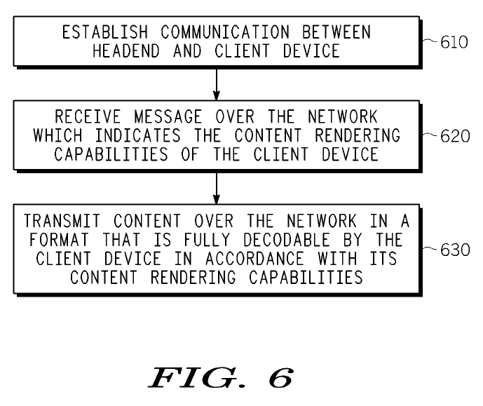

FIG. 6 is a flowchart illustrating one example of a method for delivering content to a client device over a network. The method begins in step 610 when communication is established between a headend and a client device over the network. The communication may be initiated by either the headend or the client device. Next, in step 620, a message is received over the network. The message specifies or otherwise indicates the content rendering capabilities of the client device. The message may be communicated while the communication session is being established between the headend and the client device using, for instance, any of a variety of signaling protocols. The message may be requested by the headend or simply included with other information that the client device delivers to the headend while the communication session is being established. Based on the content rendering capabilities of the client device received in the message, the headend, in step 630, transmits content over the network in a format that is fully decodable by the client device in accordance with its content rendering capabilities. For instance, if the content is scalable coded into two or more layers, only the number of layers that can be decoded and rendered by the client device are transmitted by the headend.

The processes described above may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, or silicon memory (e.g., removable, non-removable, volatile or non-volatile.

Although various embodiments are specifically illustrated and described herein, it will be appreciated that modifications and variations of the present invention are covered by the above teachings and are within the purview of the appended claims without departing from the spirit and intended scope of the invention. For example, while the video transport stream has been described in terms of an MPEG Transport Stream, other types of video transport streams may be employed as well. Similarly, content delivery mechanisms over IP and other networks may operate in accordance with standards and recommendations other than RTP, which has been presented for purposes of illustration. 21. In addition to, or instead of varying the number of layers that are delivered to the client devices based on their characteristics (e.g., resolution capability), in some implementations the number of scalable layers that are delivered may be varied dynamically to adjust to changing network bandwidth availability.

1. A method of delivering content to a client device over a network, comprising:
establishing communication with a first client device over a network;
receiving over the network a first message that indicates content rendering capabilities of the first client device; and
based on the first message, transmitting content to the first client device over the network in a format that is fully decodable by the first client device in accordance with its content rendering capabilities.

2. The method of claim 1 wherein the content is scalable coded into a plurality of layers and further comprising transmitting a selected number of the layers to the first client device based on the content rendering capabilities of the first client device.

3. The method of claim 1 wherein the content comprises video content and the content rendering capabilities include a display resolution capability of the first client device.

4. The method of claim 1 wherein the content is streamed to the first client device.

5. The method of claim 2 further comprising:
receiving the content in a scalable coded format; and
transcoding the content to select the layers to be transmitted to the first client device.

6. The method of claim 1 further comprising transforming the content from a video transport stream to an IP transport stream.

7. The method of claim 6 wherein the video transport stream is an MPEG Transport Stream and the IP transport stream includes at least one RTP transport stream.

8. The method of claim 1 wherein the first message is received in accordance with a session-establishing signaling protocol.

9. The method of claim 1 further comprising:
establishing communication with a second client device over the network;
receiving over the network a second message that indicates content rendering capabilities of the second client device; and
based on the second message, transmitting the content to the second client device over the network in a second format that is fully decodable by the second client device in accordance with its content rendering capabilities.

10. The method of claim 9 wherein the second format is different from the first format and the content is scalable coded into a plurality of layers and the first format includes a first number of layers of the scalable coded content and the second format includes a second number of layers of the scalable coded content, wherein the first and second number of layers are different from one another.

11. A headend for delivering content over one or more networks, comprising:
a scalable transcoder for receiving programming content and generating a scalably encoded programming stream therefrom, the scalably encoded programming stream including a plurality of layers; and
a streaming server for receiving the scalably encoded programming stream, wherein the streaming server, responsive to a user request for the programming content, is configured to output for transmission over a network a transport stream in which the content is encoded at a bit rate corresponding to a resolution capability of a client device from which the user request is received.

12. The headend of claim 11 further comprising a gateway for transforming the transport stream that is transmitted over the network from a video transport format to an IP transport format.

13. The headend of claim 12 wherein the video transport format is an MPEG format and the IP transport format is RTP.

14. The headend of claim 11 wherein the streaming server is configured to receive the user request in accordance with a SIP or RTSP signaling protocol.

15. At least one computer-readable medium encoded with instructions which, when executed by a processor, performs a method including:
based on a characteristic of a first client device, selecting a first number of layers of a scalable coded content file;
delivering the first number of layers to the first client device over a network;
based on a characteristic of a second first client device, selecting a second number of layers of the scalable coded content file; and
delivering the second number of layers to the second client device over the network.

16. The computer-readable medium of claim 15 wherein the first number of layers is streamed to the first client device in an MPEG transport stream and the second number of layers is streamed to the second client device in an RTP transport stream.

17. The computer-readable medium of claim 15 wherein the characteristic of the first and second client devices includes a display resolution capability.

18. The computer-readable medium of claim 16 further comprising transforming the second number of layers from an MPEG transport stream to the RTP transport stream.

19. The computer-readable medium of claim 15 further comprising transcoding the scalable coded file content to select the first and second number of layers.

20. The computer-readable medium of claim 17 wherein the first number of layers consumes less bandwidth than the second number of layers and the display resolution capability of the first client device is less than the display resolution capability of the second client device.

21. The computer-readable medium of claim 15 wherein the first and second number of layers may be varied dynamically to adjust to changing network bandwidth availability.
